(19) United States
(12) Patent Application Publication
(10) Pub. No.: US 2007/0057001 A1
(43) Pub. Date: Mar. 15, 2007

(54) Article support rack

(76) Inventor: Lo Pin Wang, Taichung (TW)

Correspondence Address: CHARLES E. BAXLEY, ESQ., 90 JOHN STREET, THIRD FLOOR, NEW YORK, NY, 10038, US

(21) Appl. No.: 11/226,940

(22) Filed: Sep. 14, 2005

(51) Int. Cl. B60R 11/00; A47F 7/00; B60R 9/00

(52) U.S. Cl. 224/536; 224/521; 224/570; 224/924; 211/17

(57) ABSTRACT

An article support rack includes a securing device having an attaching member for attaching onto a support member of a portable frame, and having a shank extended from the attaching member, a fixed pawl is attached to the shank, a rotatable pawl is attached to the shank and movable toward and away from the fixed pawl, for selectively retaining an article between the pawls. A spring biased latch may be used for latching the rotatable pawl to the shank, to selectively secure the rotatable pawl to the shank and the fixed pawl at selected angular position, and for selectively retaining an article between the pawls. A lock device includes an actuator for selectively moving the latch relative to the shank.

### BACKGROUND OF THE INVENTION

1. Field of the Invention

The present invention relates to an article support rack, and more particularly to an article support rack having a solid securing mechanism for solidly securing articles onto the support rack that is adapted to be detachably interconnected with a vehicle, such as an automobile, truck or trailer.

2. Description of the Prior Art

Various kinds of typical article support racks have been developed and adapted to be detachably interconnected with a vehicle, such as an automobile, truck or trailer, and comprise a connecting member for attaching or securing onto the vehicle, automobile, truck or trailer.

For example, U.S. Pat. No. 5,518,159 to DeGuevara discloses one of the typical article support racks for detachably interconnecting with a vehicle, automobile, truck or trailer, and comprising a pair of article support members extended outwardly from a cross-bar that is disposed or supported on top of a column, for supporting articles or bicycles thereon.

However, the articles or bicycles are simply disposed or supported on top of the article support members, and the typical article support rack has no fastening devices for anchoring or securing the articles or bicycles on the article support members, such that the articles or bicycles may not be solidly secured to the article support members, and such that the articles or bicycles may be easily disengaged from the article support members, particularly when the vehicle moves across wavy or bumpy roads.

U.S. Pat. No. 6,513,691 to Edgerly discloses another typical article support rack comprising a portable frame for detachably interconnecting with a vehicle, automobile, truck or trailer, and comprising a pair of brackets for supporting articles or bicycles thereon, and two conformable straps attached onto each of the brackets, for anchoring or securing the articles or bicycles onto the brackets, and the conformable straps are attached or secured to the brackets with hook and loop fastening devices.

However, the when the articles or bicycles are disposed or supported on top of the brackets with the hook and loop fastening devices, the articles or bicycles may be swung or vibrated relative to the brackets, and the hook and loop fastening devices may be easily released or unfastened or disengaged from the brackets, particularly when the vehicle moves across wavy or bumpy roads.

The present invention has arisen to mitigate and/or obviate the afore-described disadvantages of the conventional article support racks.

### SUMMARY OF THE INVENTION

The primary objective of the present invention is to provide an article support rack including a solid securing mechanism for solidly securing articles or bicycles onto the support rack that is adapted to be detachably interconnected with the vehicle, such as automobile, truck or trailer.

In accordance with one aspect of the invention, there is provided an article support rack comprising a support member, a securing device including an attaching member, such as a tubular attaching member for attaching onto the support member, and including a shank extended from the attaching member, a first pawl attached to the shank, a second pawl rotatably attached to the shank, and movable toward and away from the first pawl, for selectively retaining an article between the first and the second pawls, and a latching device for latching the second pawl to the shank, to selectively secure the second pawl to the shank and the first pawl at selected angular position, and for selectively retaining an article between the first and the second pawls, and for preventing the article from being disengaged from the support member.

The first pawl includes a barrel attached to the shank. The barrel of the first pawl includes a notch formed therein, and the shank includes at least one protrusion extended therefrom, and engaged into the notch of the barrel of the first pawl, for anchoring the first pawl to the shank.

The second pawl includes a barrel rotatably attached to the shank, a spring member disposed between the barrels of the first and the second pawls, and coupled to the barrels, for biasing the first and the second pawls away from each other. The first and the second pawls each includes a peripheral recess formed therein for receiving the spring member. The barrels of the first and the second pawls each includes a hole formed therein, and the spring member includes two ends engaged into the holes of the barrels respectively.

The second pawl includes an internal gear provided therein, the latching device includes a latch slidably attached to the shank and having at least on tooth provided thereon, for engaging with the internal gear, and for selectively anchoring the second pawl to the shank at selected angular position.

The latching device includes a spring member engaged between the shank and the latch, for biasing the tooth of the latch to engage with the internal gear. A lock device is attached to the shank and includes an actuator extended therefrom, for engaging with and for moving the latch relative to the shank.

The latch includes an opening formed therein, the actuator of the lock device is engaged into the opening of the latch, and for moving the latch relative to the shank. The shank includes a cap secured thereto, and having an orifice formed therein for receiving the lock device therein. The shank includes a chamber formed therein, and includes a groove formed therein and communicating with the chamber thereof, for receiving the latch therein, and for guiding the latch to slide relative to the shank.

A ring may further be provided and attached onto the shank and including a pad disposed thereon, for engaging with and for safely supporting the article, and for preventing the article from being scraping or damaged by the pawls. The ring includes a notch formed therein, and the shank includes at least one protrusion extended therefrom, and engaged into the notch of the ring, for anchoring the ring to the shank.

The securing device includes a clamping device for selectively clamping the attaching member to the support member. For example, the clamping device includes a cam member pivotally attached to the attaching member, and rotatable relative to the attaching member, for selectively clamping the attaching member to the support member.

The attaching member includes a flexible sleeve engaged between the attaching member and the support member, the cam member is engageable with the flexible sleeve. The attaching member includes a passage formed therein, the sleeve includes at least one projection engaged into the passage of the attaching member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an article support rack in accordance with the present invention;

FIG. 2 is a rear perspective view of a clamping or securing device for the article support rack;

FIG. 3 is a front perspective view of the clamping or securing device for the article support rack;

FIG. 4 is an exploded view of the clamping or securing device for the article support rack;

FIG. 5 is a cross sectional view of the article support rack, taken along lines 5-5 of FIG. 3;

FIG. 6 is a cross sectional view similar to FIG. 5, illustrating the operation of the article support rack;

FIGS. 7, 8 are cross sectional views of the article support rack, taken along lines 7-7, and 8-8 of FIG. 5 respectively; and

FIG. 9 is a cross sectional view similar to FIG. 8, illustrating the operation of the article support rack.

### DETAILED DESCRIPTION OF THE PREFERRED EMBODIMENT

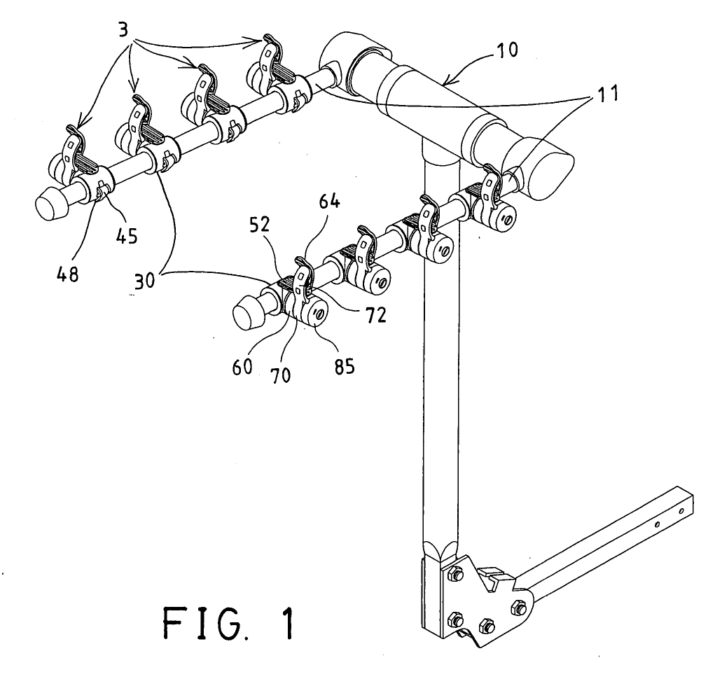

Referring to the drawings, and initially to FIGS. 1-5, an article support rack in accordance with the present invention comprises a portable frame 10 for detachably interconnecting with a vehicle (not shown), such as an automobile, truck or trailer, and including a pair of support members 11 extended therefrom for supporting articles or bicycles (not shown) thereon, and one or more clamping or securing devices 3 attached onto each of the support members 11 of the portable frame 10, for solidly anchoring or securing the articles or bicycles onto the support members 10, and for preventing the articles or bicycles from being disengaged from the support members 10.

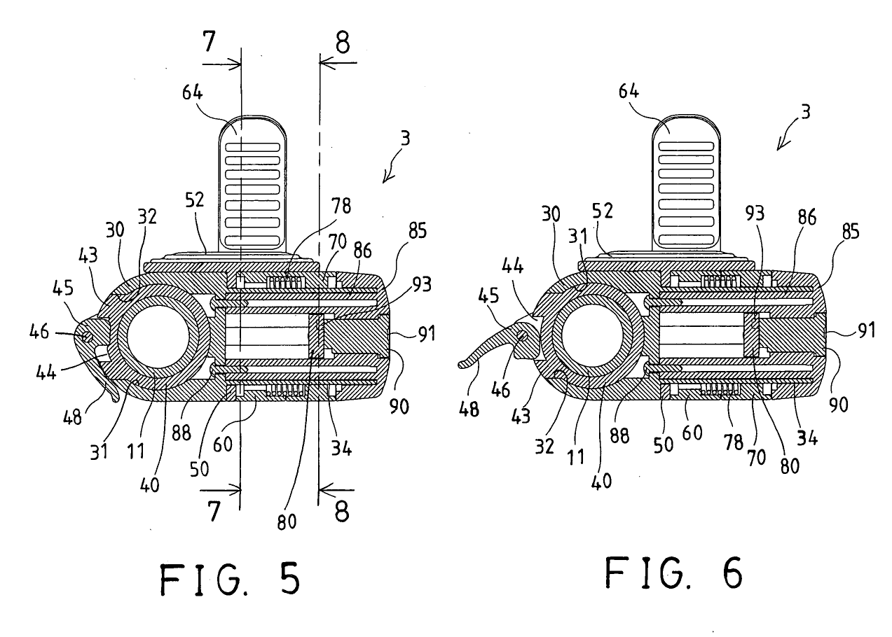

Each of the clamping or securing devices 3 includes a tubular attaching member 30 having a bore 31 formed therein for receiving and for attaching onto the support member 11 of the portable frame 10, and having a passage 32 formed therein and communicating with the bore 31 thereof, and a resilient or flexible sleeve 40 is engaged into the bore 31 of the attaching member 30, and also includes a bore 41 formed therein for receiving the support member 11 of the portable frame 10, and for allowing the resilient or flexible sleeve 40 to be disposed or engaged between the attaching member 30 and the support member 11 of the portable frame 10, best shown in FIGS. 5, 6.

The resilient or flexible sleeve 40 includes two end peripheral flanges 42 for engaging with the attaching member 30, and for positioning or anchoring the sleeve 40 to the attaching member 30. The sleeve 40 is preferably made of resilient or flexible rubber or plastic materials, to allow the end peripheral flanges 42 of the sleeve 40 to be engaged into the bore 31 of the attaching member 30. The sleeve 40 further includes one or more projections 43 extended therefrom, for engaging into the passage 32 of the attaching member 30, and for further positioning or anchoring the sleeve 40 to the attaching member 30, and includes a space 44 (FIGS. 5, 6) formed or defined between the projections 43.

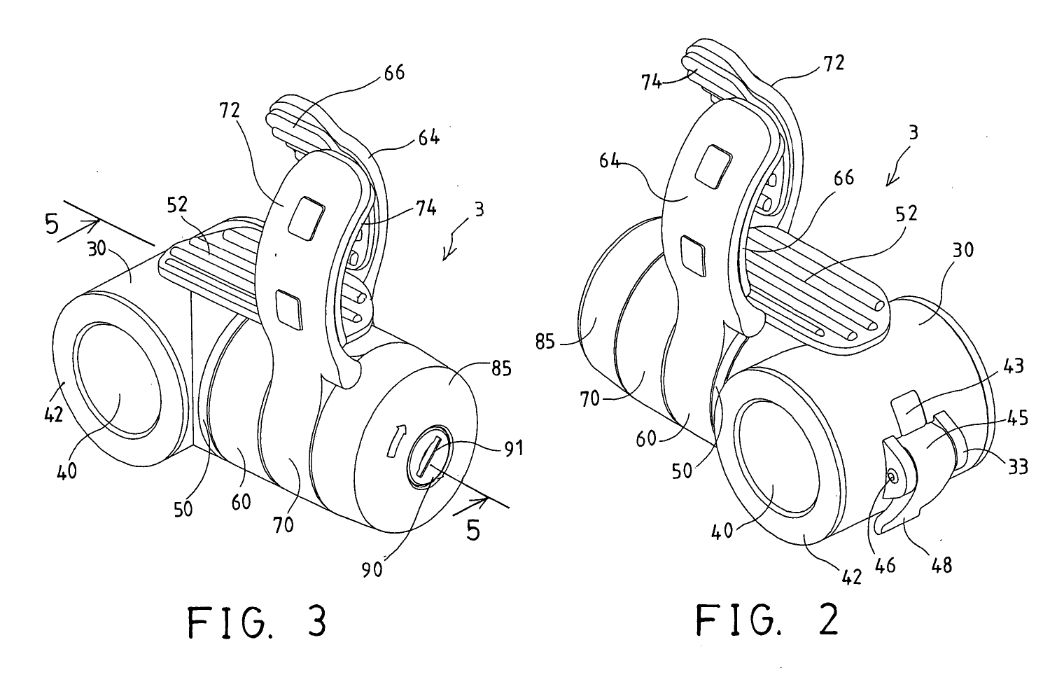

A cam member 45 is rotatably or pivotally attached to the attaching member 30, such as rotatably or pivotally attached, with a pivot pin 46, to two ears 33 that are extended from the attaching member 30 (FIG. 2) and located beside the passage 32 of the attaching member 30, and includes a handle 48 extended therefrom for being rotated by the users, in order to rotate the cam member 45 relative to the attaching member 30. The cam member 45 is rotatable relative to the attaching member 30 by the handle 48, and directly engageable with the support member 11 of the portable frame 10, or indirectly engageable with the support member 11 via the sleeve 40, in order to form or to act as a quick release locking or clamping device, and in order to detachably or releasably securing the attaching member 30 of the clamping or securing device 3 to the portable frame 10, best shown in FIGS. 5, 6.

The attaching member 30 includes a tube or shank 34 extended therefrom and preferably arranged perpendicular to the attaching member 30, and having a relatively reduced outer diameter, in order to form a peripheral shoulder 35 between the shank 34 and the attaching member 30, and further includes one or more protrusions or juts 36 extended from the shank 34 or the attaching member 30, and preferably arranged or located within the peripheral shoulder 35 of the shank 34 and the attaching member 30. The shank 34 includes a chamber 37 formed therein, and a groove 38 laterally formed therein and intersecting or communicating with the chamber 37 thereof, and one or more channels 39 formed therein and parallel to and communicating with the chamber 37 thereof.

A ring 50 is attached or engaged onto the shank 34, and includes a notch 51 formed therein for receiving or engaging with the juts 36, and for positioning or anchoring the ring 50 to the shank 34, and for preventing the ring 50 from being rotated relative to the shank 34. The ring 50 includes a resilient pad 52 disposed or attached thereon, for engaging with and for safely support the articles or bicycles thereon.

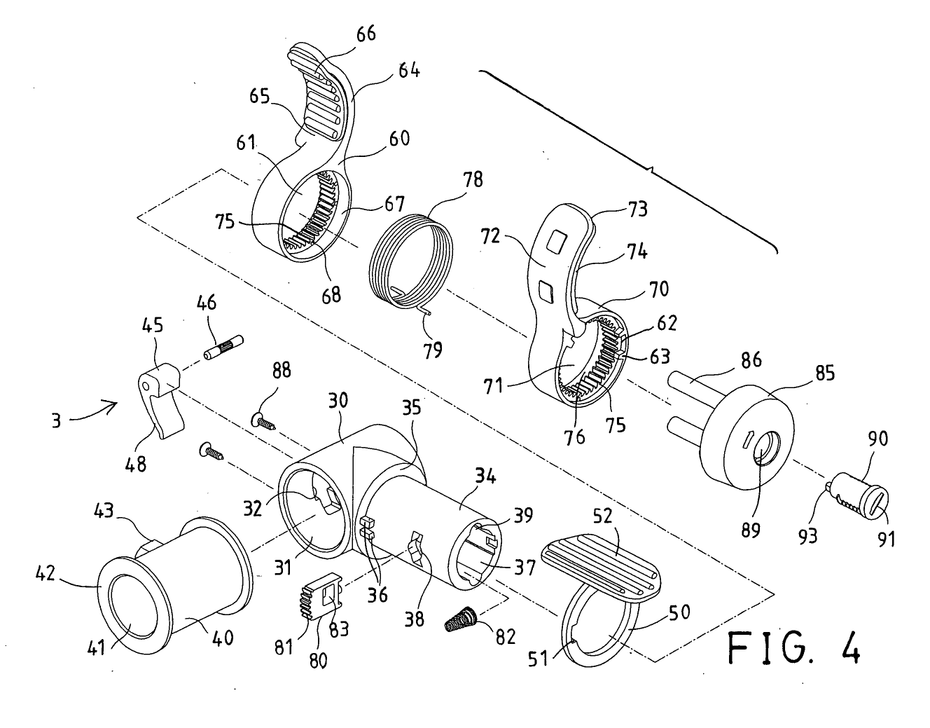

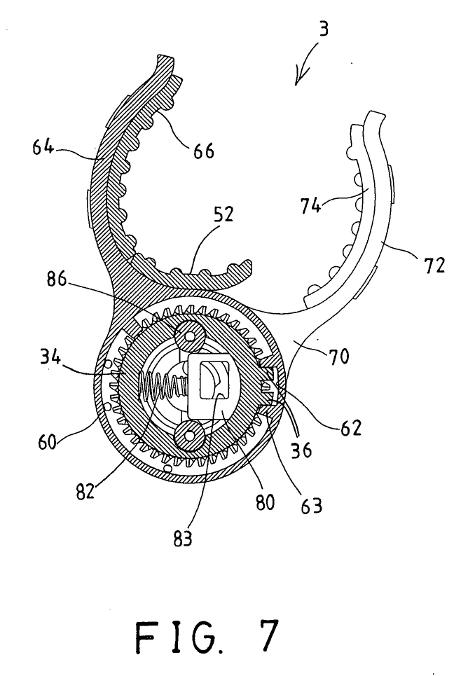

A fixed or first barrel 60 includes a bore 61 formed therein for receiving or engaging onto the shank 34, and includes a notch 62 formed therein and defined between two swellings 63 (FIG. 7), for receiving or engaging with the juts 36, and for positioning or anchoring the barrel 60 to the shank 34, and for preventing the barrel 60 from being rotated relative to the shank 34. The barrel 60 includes a pawl 64 extended therefrom and having an inwardly curved surface 65 formed therein, and a resilient or cushioning or soft pad 66 attached or secured to the curved surface 65 thereof, for engaging with the articles or bicycles that are supported on the pad 52 of the ring 50. The barrel 60 includes a peripheral recess 67 and a hole 68 formed therein, and communicating with each other, best shown in FIG. 4.

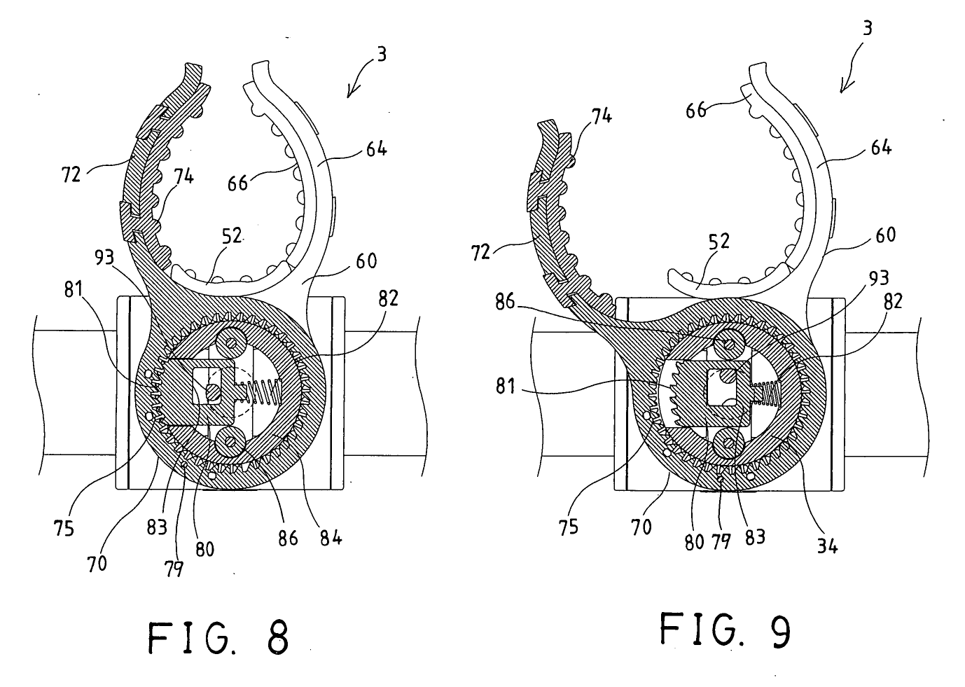

Another or rotatable or second barrel 70 also includes a bore 71 formed therein for rotatably receiving or engaging onto the shank 34, and for allowing the barrel 70 to be rotated relative to the shank 34, and also includes a pawl 72 extended therefrom and having an inwardly curved surface 73 formed therein, and a resilient or cushioning or soft pad 74 attached or secured to the curved surface 73 thereof, for engaging with the articles or bicycles that are supported on the pad 52 of the ring 50. The barrel 70 includes an internal gear or a number of teeth 75 formed or provided therein, and also includes a peripheral recess 76 (FIG. 4) and a hole 77 formed therein (FIGS. 8, 9).

A spring member 78 may be attached or engaged onto the shank 34, and received in the peripheral recesses 67, 76 of the barrels 60, 70, and includes two ends 79 for engaging into the holes 68, 77 of the barrels 60, 70 respectively, for allowing the spring member 78 to apply a spring biasing force against the barrel 70, or to bias and force the barrel 70 to rotate relative to the other barrel 60, and/or to open or to move the pawls 64, 72 toward or away from each other. For example, the spring member 78 may preferably be used to bias and to open or to move the pawls 64, 72 away from each other, for allowing the articles or bicycles to be easily disposed between the pawls 64, 72, and to be supported on the pad 52 of the ring 50.

A slidable latch 80 is slidably engaged in the groove 38 of the shank 34, and includes one or more teeth 81 formed or provided thereon, for engaging with the internal gear or teeth 75 of the barrel 70, and for selectively positioning or anchoring the barrel 70 to the shank 34 at selected or required angular position. Another spring member 82 may be received in the shank 34, and attached or engaged between the shank 34 and the latch 80, for biasing the teeth 81 of the latch 80 to engage with the internal gear or teeth 75 of the barrel 70, and thus to position or anchor or secure the barrel 70 to the shank 34 and the other barrel 60 at selected or required angular position. The latch 80 may be used as a latching means for latching the barrel 70 to the shank 34 at selected or required angular position, and includes an opening 83 formed therein.

A cap 85 is attached or secured to the shank 34. For example, the cap 85 includes one or more, such as two poles 86 extended therefrom, and engaged into the channels 39 of the shank 34 respectively, and secured to the shank 34 with such as fasteners 88 (FIGS. 5, 6), The cap 85 includes an orifice 89 formed therein for rotatably receiving a lock device 90 therein which may thus be attached to the shank 34 and which includes a slot 91 formed therein for receiving the selected or predetermined key member (not shown), and includes a catch or actuator 93 extended therefrom, for engaging into the opening 83 of the latch 80, and thus for moving the latch 80 against the spring member 82 (FIGS. 8, 9).

In operation, when the selected or predetermined key member is engaged into the slot 91 of the lock device 90, to rotate the lock device 90 relative to the shank 34, the actuator 93 of the lock device 90 may engage with the latch 80, and may move the latch 80 against the spring member 82, in order to disengage the teeth 81 of the latch 80 from the internal gear or teeth 75 of the barrel 70, and thus to release and to allow the barrel 70 to be rotated relative to the shank 34 and relative to the other barrel 60, and thus to open or to move the pawls 64, 72 away from each other, and to allow the articles or bicycles to be easily disposed between the pawls 64, 72, and to be supported on the pad 52 of the ring 50.

After the articles or bicycles have been disposed between the pawls 64, 72 and supported on the pad 52 of the ring 50, the user may rotate or move the pawl 72 toward the other pawl 64, in order to have the articles or bicycles to be solidly anchored or secured or positioned or grasped or retained between the pawls 64, 72. It is preferable that the teeth 81 of the latch 80 are ratchet teeth and arranged to allow the pawl 72 of the rotatable barrel 70 to be easily rotated or moved toward the other pawl 64 of the other barrel 60 without moving or disengaging the teeth 81 of the latch 80 from the internal gear or teeth 75 of the barrel 70.

After the articles or bicycles have been solidly clamped or secured between the pawls 64, 72 of the barrels 60, 70, the teeth 81 of the latch 80 may be biased to engage with the internal gear or teeth 75 of the barrel 70 by the spring member 82, in order to solidly secure the pawls 64, 72 of the barrels 60, 70 together. The teeth 81 of the latch 80 may not be disengaged from the internal gear or teeth 75 of the barrel 70 against the spring member 82, unless the selected or predetermined key member is engaged into the slot 91 of the lock device 90 to rotate the lock device 90 relative to the shank 34 and to actuate the actuator 93 of the lock device 90 to move the latch 80 against the spring member 82.

It is to be noted that the barrels 60, 70 and the pawls 64, 72 may include identical structure and may be disposed in opposite direction, and may thus be made of the same mold device, such that the manufacturing cost may be reduced. The barrel 60 may thus also include a notch 62 formed therein and defined between two swellings 63 (FIG. 4), and the barrel 70 may also include the teeth 75 (FIG. 4) formed or provided therein.

Accordingly, the article support rack in accordance with the present invention includes a solid securing mechanism for solidly securing articles or bicycles onto the support rack that is adapted to be detachably interconnected with the vehicle, such as automobile, truck or trailer.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An article support rack comprising:
a support member,
a securing device including an attaching member for attaching onto said support member, and including a shank extended from said attaching member,
a first pawl attached to said shank,
a second pawl rotatably attached to said shank, and movable toward and away from said first pawl, for selectively retaining an article between said first and said second pawls, and
means for latching said second pawl to said shank, to selectively secure said second pawl to said shank and said first pawl at selected angular position, and for selectively retaining an article between said first and said second pawls.

2. The article support rack as claimed in claim 1, wherein said first pawl includes a barrel attached to said shank.

3. The article support rack as claimed in claim 2, wherein said barrel of said first pawl includes a notch formed therein, and said shank includes at least one protrusion extended therefrom, and engaged into said notch of said barrel of said first pawl, for anchoring said first pawl to said shank.

4. The article support rack as claimed in claim 2, wherein said second pawl includes a barrel rotatably attached to said shank, a spring member disposed between said barrels of said first and said second pawls, and coupled to said barrels, for biasing said first and said second pawls away from each other.

5. The article support rack as claimed in claim 4, wherein said first and said second pawls each includes a peripheral recess formed therein for receiving said spring member.

6. The article support rack as claimed in claim 4, wherein said barrels of said first and said second pawls each includes a hole formed therein, and said spring member includes two ends engaged into said holes of the barrels respectively.

7. The article support rack as claimed in claim 1, wherein said second pawl includes an internal gear provided therein, said latching means includes a latch slidably attached to said shank and having at least on tooth provided thereon, for engaging with said internal gear, and for selectively anchoring said second pawl to said shank at selected angular position.

8. The article support rack as claimed in claim 7, wherein said latching means includes a spring member engaged between said shank and said latch, for biasing said at least one tooth of said latch to engage with said internal gear.

9. The article support rack as claimed in claim 7, wherein a lock device is attached to said shank and includes an actuator extended therefrom, for engaging with and for moving said latch relative to said shank.

10. The article support rack as claimed in claim 9, wherein said latch includes an opening formed therein, said actuator of said lock device is engaged into said opening of said latch, and for moving said latch relative to said shank.

11. The article support rack as claimed in claim 9, wherein said shank includes a cap secured thereto, and having an orifice formed therein for receiving said lock device therein.

12. The article support rack as claimed in claim 7, wherein said shank includes a chamber formed therein, and includes a groove formed therein and communicating with said chamber thereof, for receiving said latch therein.

13. The article support rack as claimed in claim 1 further comprising a ring attached onto said shank and including a pad disposed thereon, for engaging with the article.

14. The article support rack as claimed in claim 13, wherein said ring includes a notch formed therein, and said shank includes at least one protrusion extended therefrom, and engaged into said notch of said ring, for anchoring said ring to said shank.

15. The article support rack as claimed in claim 1, wherein said securing device includes means for clamping said attaching member to said support member.

16. The article support rack as claimed in claim 15, wherein said clamping means includes a cam member pivotally attached to said attaching member, and rotatable relative to said attaching member, for clamping said attaching member to said support member.

17. The article support rack as claimed in claim 16, wherein said attaching member includes a sleeve engaged between said attaching member and said support member, said cam member is engageable with said sleeve.

18. The article support rack as claimed in claim 17, wherein said attaching member includes a passage formed therein, said sleeve includes at least one projection engaged into said passage of the attaching member.
